(19) United States
(12) Patent Application Publication
(10) Pub. No.: US 2014/0073370 A1
(43) Pub. Date: Mar. 13, 2014

(54) METHOD OF MOBILE DEVICE RESOURCE REUSE IN MOBILE CLOUD

(71) Applicant: Electronics and Telecommunications Research Institute, Daejeon (KR)

(72) Inventors: Kang-Chan LEE, Daejeon (KR); Min-Kyo IN, Daejeon (KR); Sung-Han KIM, Daejeon (KR); Jong-Hong JEON, Daejeon (KR); Seung-Yun LEE, Daejeon (KR)

(21) Appl. No.: 13/941,020

(22) Filed: Jul. 12, 2013

(30) Foreign Application Priority Data
Sep. 7, 2012 (KR) 10-2012-0099574
Dec. 31, 2012 (KR) 10-2012-0158445

(51) Int. Cl. H04W 72/04

(52) U.S. Cl. CPC H04W 72/04
USPC 455/509

(57) ABSTRACT

Provided is a method of reusing a mobile device resource in a mobile cloud. According to an embodiment, the method may be a method for using a mobile device resource of a mobile device resource provider in the mobile cloud, the method including requesting use of at least one of the mobile device resources from the mobile device resource provider, wherein the mobile device resource includes content stored by the mobile device resource provider, a function provided to the mobile device resource provider, and an application installed to the mobile device resource provider; and receiving the requested mobile device resource of the mobile device resource provider, wherein, when use of the content is requested, the requested content may be received through download or streaming, and, when use of the function or the application is requested, a result of executing the function or the application may be received.

### CROSS-REFERENCE TO RELATED APPLICATION

This application claims the benefit under 35 U.S.C. §119(a) of a Korean Patent Application Nos. 10-2012-0099574, filed on Sep. 7, 2012, and 10-2012-0158445, filed on Dec. 31, 2012, in the Korean Intellectual Property Office, the entire disclosure of which is incorporated herein by reference for all purposes.

### BACKGROUND

1. Field

The following description relates to a mobile cloud, and more particularly, to a method of reusing, by a mobile device, a resource of another mobile device in a mobile cloud.

2. Description of the Related Art

Cloud computing enables not only users but also providers to share various IT resources such as networks, servers, and storages. That is, the users or providers using the cloud computing may use, via an Internet network (online), necessary computing resources from the IT resources shared in a server side at anytime and anywhere.

The clouding computing involves elements for supporting various services. For example, the cloud computing involves elements for supporting software as a server (SaaS), infra as a service (IaaS), platform as a service (PaaS), and device as a service (DaaS).

The cloud computing is currently provided through a computing service based on servers interconnected via a wired network. The researches for applying the cloud computing to mobile devices are actively conducted. A mobile cloud is an extended concept of the server-based cloud computing for applying the cloud computing to mobile devices. With the development of information and communications technology, a mobile device using the cloud computing is a thin client or a zero client required to have computing performance and minimal functions required for the cloud computing. However, with the development of the information and communications technology, mobile devices such as smartphones or pads have also been improved to have better performance and more various functions.

The mobile cloud provides a server-based cloud computing service to a mobile application service developer and a mobile device user, and indicates a new concept of cloud for sharing mobile device resources between mobile devices. The cloud computing service will be developed to a core technology for providing a service between wired/wireless terminals in a mobile environment. A core technology element of a mobile platform for providing an optimal service to a mobile device is a technique of reusing mobile device resources in the mobile cloud.

In relation to reuse of mobile device resources, various methods for sharing IT resources, specifically content, between individual mobile devices have been suggested. For example, Korean Patent Application Laid-open No. 2010-0026874, entitled “SYSTEM AND METHOD FOR SHARING RESOURCES BETWEEN DEVICES”, discloses a method for overcoming limitations of content sharing between computers through the conventional Internet. According to this method, data (phone numbers, pictures, videos, etc.) are retrieved among mobile communication terminals based on a mobile communication network, and a system for the retrieved data to be requested/provided is disclosed. However, this technique of reusing mobile device resources relates to simple resource sharing between individual mobile devices. Moreover, resources to be shared are limited to data or content such as phone numbers, pictures, videos, etc.

### SUMMARY

With the proliferation of mobile devices and the development of cloud computing, mobile cloud services become more potential and are expected to be a new growth power in the IT field. Since mobile devices have been developed to have a high speed and high capacity, it becomes more necessary to reuse resources of the high-performance mobile devices.

The following description relates to a method of reusing a mobile device resource in a mobile cloud for allowing a mobile device to search for and use various mobile device resources possessed by another mobile device.

Also, the following description relates to a method of reusing a mobile device resource in a mobile cloud for allowing a mobile device to use high computing performance and various functions possessed by another mobile device.

In one general aspect, there is provided a method of using mobile device resources of a mobile device resource provider in a mobile cloud, and the method includes requesting use of at least one of the mobile device resources from the mobile device resource provider, wherein the is mobile device resources include content stored by the mobile device resource provider, a function provided to the mobile device resource provider, and an application installed to the mobile device resource provider; and receiving the requested mobile device resource of the mobile device resource provider, wherein, when the requesting of use of at least one of the mobile device resources is a request for use of the content, the requested content is received through download or streaming for the receiving of the requested mobile device resource, and when the requesting of use of at least one of the mobile device resources is a request for use of the function or the application, a result of executing the function or the application is received for the receiving of the requested mobile device resource.

The method may further include requesting an authority to use the at least one of the mobile device resources from the mobile device resource provider and receiving the authority, before the receiving of the requested mobile device resource.

The method may further include searching for mobile device resources providable by the mobile device resource provider, before the requesting of use of at least one of the mobile device resources, wherein the requesting of use of at least one of the mobile device resources may include requesting use of at least one of the mobile device resources found as a result of the searching for mobile device resources. Each of the mobile devices found as the result of the searching for mobile device resources may include a use authority condition for using a corresponding device resource. The searching for mobile device resources may be performed in a mobile device resource information database for storing and managing information on mobile device resources providable by a plurality of mobile device resource providers.

The requesting of use of at least one of the mobile device resources and the receiving of the requested mobile device resource may be performed through a peer-to-peer communication is with the mobile device resource provider.

The requesting of use of at least one of the mobile device resources and the receiving of the requested mobile device resource may be performed through a communication with a server cloud for managing the mobile device resource information database and constructing a virtual desktop infrastructure (VDI).

The function may include at least one of a local area network function, a location measurement function, and a near field communication function possessed by the mobile device resource provider.

In another general aspect, there is provided a method of providing mobile device resources, and the method includes receiving, from the mobile device resource user, a request for use of at least one of the mobile device resources, wherein the mobile device resources include stored content, a provided function, and an installed application to a mobile device resource user; and transferring, to the mobile device resource user, the requested mobile device resource, wherein, when a request for use of the content is received as a result of the receiving of the request for use of at least one of the mobile device resources, the requested content is transferred through download or streaming for the transferring of the requested mobile device resource, and when a request for use of the function or the application is received as a result of the receiving of the request for use of at least one of the mobile device resources, a result of executing the function or the application is transferred for the transferring of the requested mobile device resource.

The method may further include receiving, from the mobile device resource user, a request for an authority to use the at least one of the mobile device resources and assigning the authority, before the transferring of the requested mobile device resource.

The method may further include receiving, from the mobile device resource user, a request for searching for mobile device resources, before the receiving of the request for use of at least one of the mobile device resources, and transferring, to the mobile device resource user, information on a providable mobile device resource in response to the search request. The transferred information on the available mobile device resource may include a use authority condition.

The method may further include registering information on a providable mobile device resource in a mobile device resource information database, before the receiving of the request for use of at least one of the mobile device resources, wherein the requested at least one of the mobile device resources may be included in the mobile device resource registered in the mobile device resource information database.

The receiving of the request for use of at least one of the mobile device resources and the transferring of the requested mobile device resource may be performed through a peer-to-peer communication with the mobile device resource user. Or, the receiving of the request for use of at least one of the mobile device resources and the transferring of the requested mobile device resource may be performed through a communication between the mobile device resource user and a server cloud for managing the mobile device resource information database and constructing a virtual desktop infrastructure (VDI).

The function may include at least one of a local area network function, a location measurement function, and a near field communication function possessed by the mobile device resource provider.

Other features and aspects will be apparent from the following detailed description, the drawings, and the claims.

### BRIEF DESCRIPTION OF THE DRAWINGS

FIG. 1 is a schematic diagram illustrating a cloud computing method for using, by a mobile device, a resource of a server cloud;

FIG. 2 is a conceptual diagram illustrating that a mobile device resource is reused in a mobile cloud according to an embodiment of the present invention;

FIG. 3 is a diagram illustrating a method of reusing a mobile device resource (MDR) according to an embodiment of the present invention;

FIG. 4 is a diagram illustrating a method of reusing a mobile device resource (MDR) according to another embodiment of the present invention;

FIG. 5A is a diagram illustrating that mobile device resources are searched for based on a server cloud;

FIG. 5B is a diagram illustrating that retrieved mobile device resources are used based on the server cloud;

FIG. 6A is a diagram illustrating that mobile device resources are searched for in a virtual desktop infrastructure (VDI) environment;

FIG. 6B is a diagram illustrating that retrieved mobile device resources are used in the VDI environment; and

FIG. 7 is a diagram illustrating that mobile device resources are searched for and used between mobile devices.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The embodiments of the present invention are based on a mobile cloud environment. The mobile cloud environment or mobile cloud indicates a model for providing another service using, individually or in groups, resources of mobiles devices desiring to be supported with a service from a cloud (hereinafter, referred to as a “mobile device resource”). In the mobile cloud environment, the mobile devices may be supported with a desired service through the cloud. The service provided in the mobile cloud environment may be provided through an active support of a service provider within the cloud instead of an active action of a user.

The mobile cloud environment to which the embodiments of the present invention are applied is different from a conventional cloud environment with respect to a client part. In the conventional cloud environment, a resource is generally provided in the format of a web regardless of a terminal environment. On the contrary, in the mobile cloud environment, the cloud may be a terminal itself such as an e-book terminal for using a cloud service in the terminal. Here, there may be a web method and an application method. According to the web method, an application uses a browser, and all application functions are implemented in a server side. This method relieves a burden of application distribution and does not depend on a platform. Further, since an application is implemented using a web standard-based interface, application development is relatively easy.

According to the application method, a resource to be reused is a nominally downloadable application. A resource is made using a dedicated application program interface (API) provided by a corresponding platform like a general application development, wherein system optimization including a user interface (UI) is easy and speed is fast.

According to the present invention, in the case where an application method in the mobile cloud, i.e. a mobile device resource to be reused, is an “application,” all information required to drive the application is provided from a mobile device resource provider. In the case where the mobile device resource to be reused is a “capability,” all information required to perform a corresponding function is provided from the mobile device resource provider. Further, the mobile device resource to be reused may be “content”. Here, the content may be provided through download or streaming.

As described above, according to a method of reusing the mobile device resource in the mobile cloud according to the embodiments of the present invention, all resources possessed by the mobile device resource provider (hereinafter, referred to as a “resource provider”) are subjects of reuse or sharing. Here, all resources possessed by the resource provider includes not only content including data such as contact information, schedules, videos, pictures, and music but also various functions provided to the resource provider together with various applications installed to the resource provider (e.g. a Bluetooth function, a GPS function, a near filed communication (NFC) function, and a camera function).

The method of reusing or sharing the mobile device resource (hereinafter, also simply referred to as a “resource”) of the resource provider may include procedures of authorization, resource search, and resource provision. For example, in the mobile cloud environment including mobile device A and mobile device B, it is assumed that a resource of mobile device A is desired to be used by mobile device B. In this case, in order to reuse the mobile device resource, an authorization procedure for assigning, by mobile device A, authority to use a resource to mobile device B, a search procedure for searching, by mobile device B, for mobile device A to find an available resource of mobile device A, and a resource provision procedure for allowing mobile device B to store, execute, or use the retrieved resource of mobile device A may be requested. In the resource provision procedure, in the case where a subject of reuse or sharing is content possessed by mobile device B, the content is provided to mobile device A through download or streaming. However, in the case where the subject of reuse or sharing is an application or function of mobile device B, a result of executing the application or function may be provided to mobile device A.

The method of reusing a mobile device resource in the mobile cloud according to the embodiments of the present invention may be implemented as (i) server cloud-based mobile device resource search and use, (ii) mobile device resource search and use between mobile devices, and (iii) mobile device resource search and use in a virtual desktop infrastructure (VDI) environment. Hereinafter, each embodiment will be described in detail.

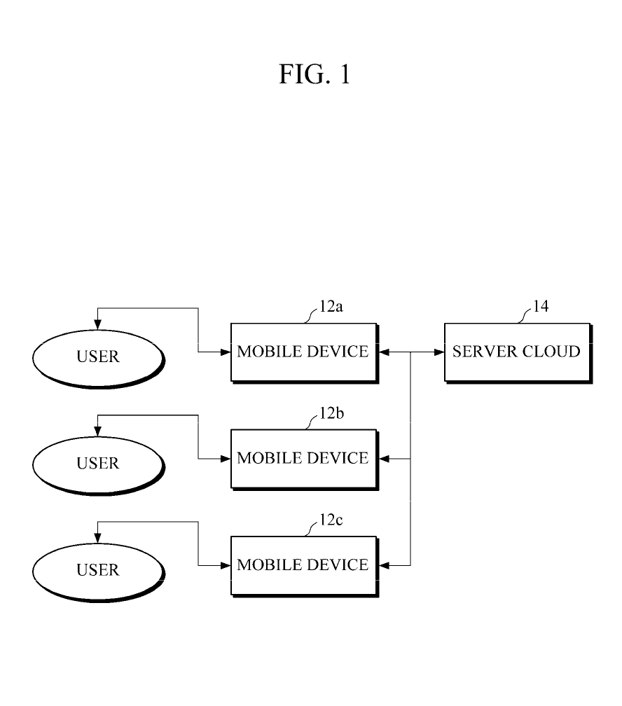

FIG. 1 is a schematic diagram illustrating a cloud computing method for using, by a mobile device, a resource of a server cloud. According to the configuration illustrated in FIG. 1, one or more mobile devices 12a to 12c may use a resource of a server cloud 14 according to a request from a user. A method of accessing, by the mobile devices 12a to 12c, the server cloud 14 is not particularly limited. This configuration is different from that of an embodiment of the present invention in that the mobile devices 12a to 12c individually access the server cloud 14 and use the resource of the server cloud 14, whereas the embodiment of the present invention is based on a premise that resources of the mobile devices 12a to 12c are used by other mobile devices in a mobile cloud environment.

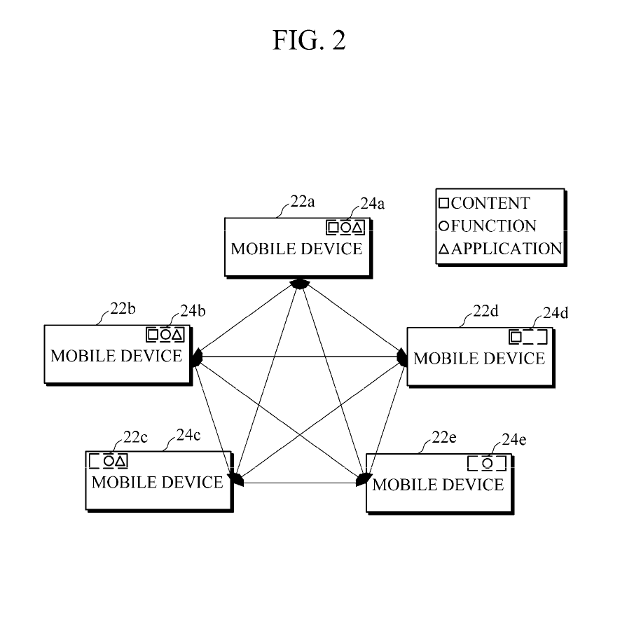

FIG. 2 is a conceptual diagram illustrating that a mobile device resource is reused in the mobile cloud. FIG. 2 illustrates a basic configuration of the mobile cloud for allowing a mobile device resource to be used by another mobile device. Referring to FIG. 2, each of mobile devices 22a to 22e includes unique mobile device resources 24a to 24e. It may be understood that each of the mobile devices 22a to 22e forming the mobile cloud may use the mobile device resources 24a to 24e possessed by other mobile devices. As described above, according to an embodiment of the present invention, a reusable mobile device resource includes stored content (indicated by a square in FIG. 2, and provided by the mobile devices 22a, 22b, and 22e), a provided function (indicated by a circle in FIG. 2, and provided by the mobile devices 22a, 22b, 22c, and 22e), and an installed application (indicated by a triangle in FIG. 2, and provided by the mobile devices 22a, 22b, and 22c).

For example, the first mobile device 22a has content, a function, and an application 24a as mobile device resources to be reused. The other mobile devices 22b to 22e forming the mobile cloud with the first mobile device 22a may use the mobile device resource 24a of the first mobile device 22a. To this end, the other mobile devices 22b to 22e may firstly obtain a right to use the mobile device resource 24a and may use the mobile device resource 24a after obtaining the right. The right of use may be obtained via a third-party authority management server or may be directly obtained from the first mobile device 22a.

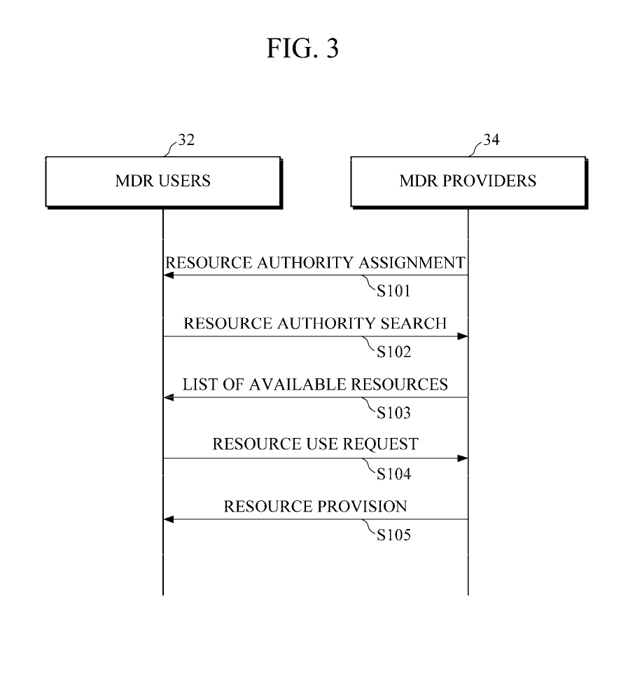

FIG. 3 is a diagram illustrating a method of reusing a mobile device resource (MDR) according to an embodiment of the present invention. According to the method illustrated in FIG. 3, resource information to be provided by a mobile device resource provider may be provided to a mobile device resource user. Although FIG. 3 illustrates one mobile device resource user 32 and one mobile device resource provider 34, the mobile device resource user and provider may be plural. In the case where a plurality of mobile device resource users 32 and a plurality of mobile device resource provider 34 exist, the operations S101 to S105 illustrated in FIG. 3 may be procedures performed by a plurality of subjects.

Referring to FIG. 3, the mobile device resource provider 34 assigns a resource authority to a specific mobile device (operation S101). In this operation, the mobile device resource provider 34 may configure a use condition for a mobile device resource possessed by the mobile device resource provider 34 and present the use condition to other mobile devices (e.g. the potential mobile device resource user 32). A mobile device that may satisfy the presented use condition may obtain a right to use a resource of the corresponding mobile device. Here, a type of the use condition is not particularly limited, and may include, for example, cost, qualifying condition, and privacy protection. Here, the mobile device resource provider 34 may also specify a type of using the mobile device resource. For example, one time use, use for a certain period, or permanent use may be specified.

The mobile device resource user 32 searches for a resource authority for a mobile device resource desired to be used (operation S102). In this operation, the mobile device resource user 32 may check the use condition presented by the mobile device resource provider 34 in operation S101. According to this operation, the mobile device resource user 32 may find at least one mobile device resource provider 34 that presents a use condition that may be accepted by the mobile device resource user 32 from among use conditions presented in operation S101. The mobile device resource user 32 may request information on a providable mobile device resource from the mobile device resource provider 34 that presents the acceptable use condition.

After the resource search is performed by the mobile device resource user 32, each of the mobile device resource providers 34 provides information on a providable mobile device resource (operation S103). In the present embodiment, a method of providing the mobile device resource information is not particularly limited. For example, as illustrated in FIG. 3, a list of available mobile device resources may be provided. The list of available mobile device resources may be information on content, function, and application that may be provided by each mobile device resource provider 34.

The mobile device resource user 32 that has received mobile device information from the mobile device resource provider 34 requests a resource use from at least one mobile device resource provider 34 that may provide a mobile device resource desired to be used by the mobile device resource user 32 (operation S104). Here, the mobile device resource user 32 specifies a mobile device resource desired to be used. Further, when there is a matter (e.g. cost or contract autograph) requested in operation S101 as a condition for obtaining the resource authority, the mobile device resource user 32 may also provide the information or data to the mobile device resource provider 34.

When it is determined that the mobile device resource user 32 that has requested the resource use has the authority, the mobile device resource provider 34 that has received the request in operation S104 provides the requested resource to the mobile device resource user 32 (operation S105). As described above, in the present operation, the provided resource may be changed according to a type of the requested resource. For example, when the requested resource is content, the content may be provided through download or streaming. When the requested resource is a function or an application, a result of executing the function or application may be provided from the mobile device resource provider 34 to the mobile device resource user 32.

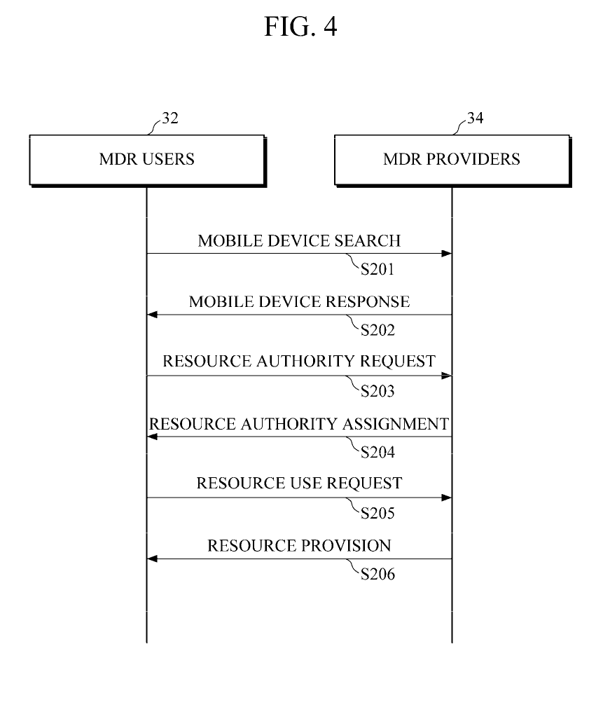

FIG. 4 is a diagram illustrating a method of reusing a mobile device resource (MDR) according to another embodiment of the present invention. According to the method illustrated in FIG. 4, the mobile device resource user may search for mobile devices that provide resources and select one of responding mobile devices to request a resource authority, and then may request a resource use after being authorized. Although FIG. 4 illustrates one mobile device resource user 32 and one mobile device resource provider 34, the mobile device resource user and provider may be plural. In the case where a plurality of mobile device resource users 32 and a plurality of mobile device resource provider 34 exist, the operations S201 to S206 illustrated in FIG. 4 may be procedures performed by a plurality of subjects.

Referring to FIG. 4, the mobile device resource user 32 searches for a mobile device having a resource desired to be used (operation S201). For example, the mobile device resource user 32 may search for a mobile device that stores content to be used, is provided with a function to be used, or has an application to be used. To this end, the mobile device resource user 32 may individually communicate with mobile devices or may access a server that manages related information.

The mobile device resource provider 34 provides a response to the search performed by the mobile device resource user 32 in operation 5201 (operation S202). In this operation, all mobile devices that have received search requests may notify whether a search-requested mobile device resource is possessed or only the mobile device resource provider 34 having the search-requested resource may respond. Or, in the case where an additional server for managing mobile device resources exists, the server may provide, to the mobile device resource user 32, information (e.g. identification information or access information) on a mobile device having the requested resource.

The mobile device resource user 32 that has received the mobile device response requests the resource authority from the corresponding mobile device resource provider 34 (operation S203). The mobile device resource provider 34 that has received the resource authority request assigns the resource authority to the mobile device resource user 32 that has requested the resource authority (operation S204). In this operation, the mobile device resource provider 34 may configure a use condition for a mobile device resource possessed by the mobile device resource provider 34 and present the use condition to a potential mobile device resource user 32. Here, a type of the use condition is not particularly limited, and may include, for example, cost, qualifying condition, and privacy protection. Here, the mobile device resource provider 34 may also specify a type of using the mobile device resource. For example, one time use, use for a certain period, or permanent use may be specified.

The mobile device resource user 32 requests a resource use from at least one mobile device resource provider 34 that may provide a mobile device resource desired to be used by the mobile device resource user 32 (operation S205). Here, the mobile device resource user 32 specifies a mobile device resource desired to be used. Further, when there is a matter (e.g. cost or contract autograph) requested in operation S204 as a condition for obtaining the resource authority, the mobile device resource user 32 may also provide the information or data to the mobile device resource provider 34.

When it is determined that the mobile device resource user 32 that has requested the resource use has the authority, the mobile device resource provider 34 that has received the request in operation S205 provides the requested resource to the mobile device resource user 32 (operation S206). As described above, in the present operation, the provided resource may be changed according to a type of the requested resource. For example, when the requested resource is content, the content may be provided through download or streaming. When the requested resource is a function or an application, a result of executing the function or application may be provided from the mobile device resource provider 34 to the mobile device resource user 32.

As described above, according to an embodiment of the present invention, the mobile device resource provider may firstly assign the resource authority or the mobile device resource user may firstly perform a search and then may request the resource authority. Since it is necessary for both the mobile device resource user and the mobile device resource provider to access each other in case of the mobile device resource to be reused, both the above-mentioned methods are supported. Therefore, through various authority assigning methods, inconvenience occurring between the mobile device resource user and the mobile device resource provider may be minimized, and frequent occurrence of authority request or authority assigning procedure may be prevented.

The above-described method of reusing a mobile device resource according to an embodiment of the present invention may be used in the following three cases. A first case is mobile device resource search and use based on a server cloud, a second case is mobile device resource search and use between mobile devices, and a third case is mobile device resource search and use in a virtual desktop infrastructure (VDI) environment. Hereinafter, the above-mentioned three cases are described under the assumption that the fifth mobile device 22e is the mobile device resource user and the other first to fourth devices 22a to 22d are the mobile device resource providers in the mobile cloud environment illustrated in FIG. 2.

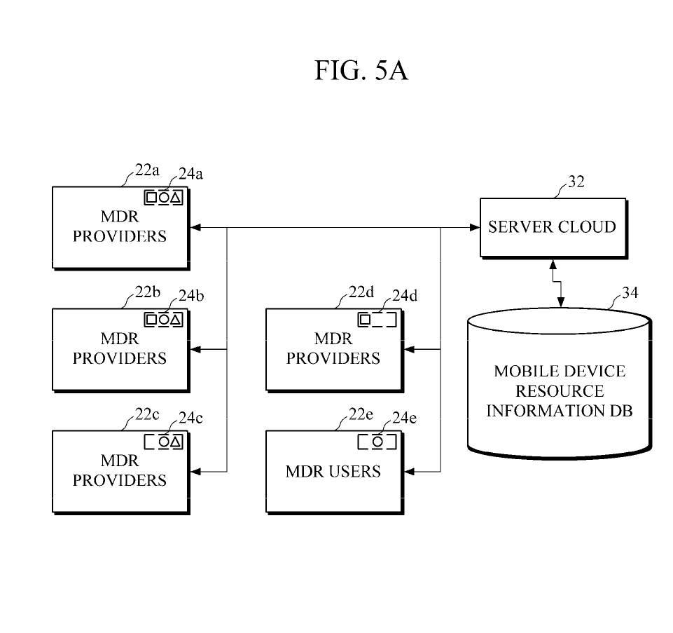

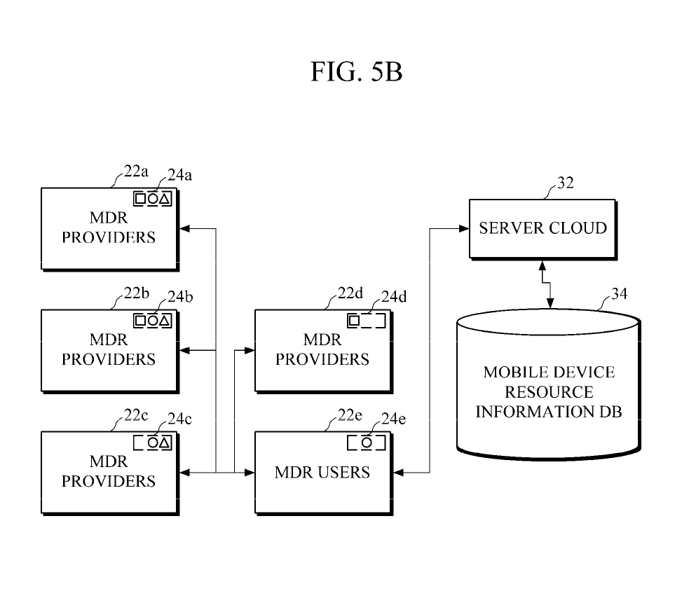

FIGS. 5A and 5B are diagrams illustrating that mobile device resources are searched for and used based on the server cloud.

Referring to FIG. 5A, the mobile device resource user 22e uses a mobile device resource information database (DB) 34 of a server cloud 32 in order to search for a mobile device and a mobile device resource. When the server cloud 32 receives, from the mobile device resource user 22e, a request for searching for an available resource and a mobile device, the server cloud 32 searches the mobile device resource information database 34 and transfers a result of the search to the mobile device resource user 22e. Based on the received mobile device and resource information, the mobile device resource user 22e requests an authority for a mobile device resource desired to be used. The authority request may be transferred to the server cloud 32 or may be directly transferred to the mobile device resource providers 22a to 22d having the desired mobile device resource.

As described above, in the example illustrated in FIG. 5A, the server cloud 32 serves as an intermediary for the mobile device resource information database 34. To this end, the server cloud 32 may collect mobile device resource information of all mobile devices 22a to 22e forming the mobile cloud, and may store and manage the collected information in the mobile device resource information database 34. For example, the mobile devices 22a to 22e may transfer locations of the mobile devices, possessed mobile device resource information, and mobile device resource authority to the server cloud 32, and the server cloud 32 may store the received information in the mobile device resource information database 34. When necessary, the mobile devices 22a to 22e may searches for resources, and may update stored information and/or authority.

FIG. 5B is a diagram illustrating that use of retrieved mobile device resource is performed through direct access between mobile devices. Referring to FIG. 5B, after being authorized, the mobile device resource user 22e directly accesses one of the mobile device resource providers 22a to 22d having a desired resource to request the resource. The mobile device resource provider that has received the resource request directly provides the requested resource to the mobile device resource user 22e.

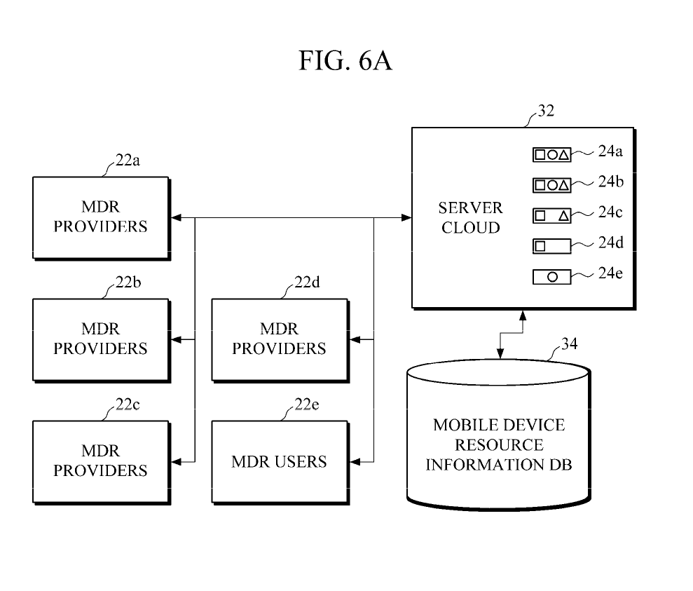

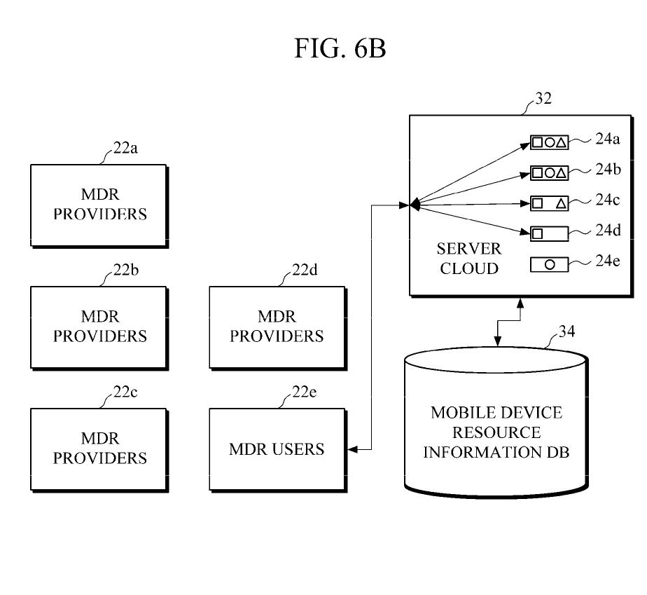

FIG. 6A is a diagram illustrating that mobile device resources are searched for in the virtual desktop infrastructure (VDI) environment, and FIG. 6B is a diagram illustrating that the retrieved mobile device resources are used in the VDI environment. In the VDI environment, resources of the mobile devices 22a to 22e, i.e. content and applications, are stored in the server cloud 32, and each mobile device 22a to 22e downloads and uses a virtual machine (VM) via the server cloud 32. That is, since the resources of the mobile devices 22a to 22e, such as the content and applications, are stored in the server cloud 32, the server cloud 32 determines whether a resource is available and transfers a result of the determination to the mobile device resource user 22e. Further, together with the authority request, a request for a mobile device resource and a provision of the mobile device resource are also performed by the server cloud 32.

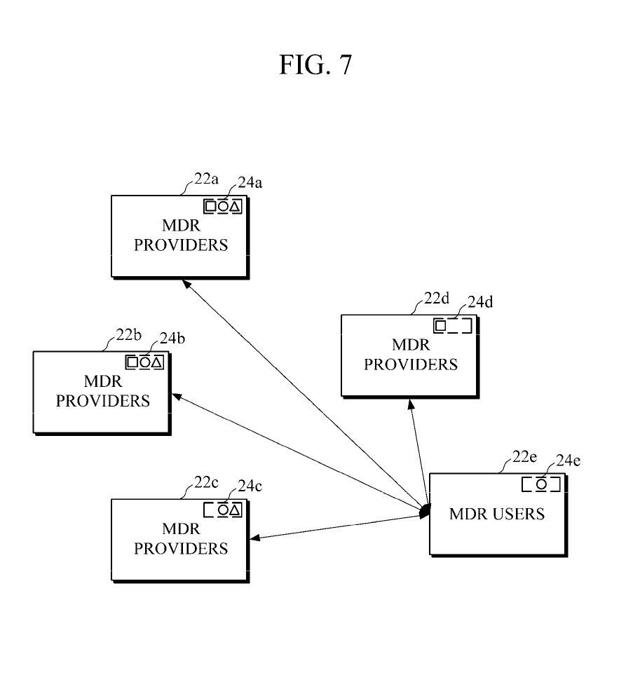

However, a function, specifically, a hardware function, from among mobile device resources, may not be stored in the server cloud 32. Therefore, for reuse of such a mobile device resource, the server cloud-based mobile device resource search and use method described above with reference to FIG. 5A or the mobile device resource search and use method between mobile devices described below with reference to FIG. 7 may be used. For example, when the mobile device resource user 22e desires to use a GPS function of the mobile device resource providers 22a to 22d, since the GPS function is not stored in the server cloud 32 but is provided to at least one of the mobile device resource providers 22a to 22d, the mobile device resource user 22e directly requests the function from the mobile device resource providers 22a to 22d and receives a result of executing the function.

FIG. 7 is a diagram illustrating that mobile device resources are searched for and used between mobile devices. According to the method illustrated in FIG. 7, the mobile device resources 24a to 24d exist in the mobile device resource providers 22a to 22d, and the mobile device resource user 22e directly requests the resources 24a to 24d from the mobile device resource providers 22a to 22d. According to this method, without an external intervention of a server, the mobile device resource user 22e may directly search for the resources 24a to 24d of the mobile device resource providers 22a to 22d, request authority to use the resources, and request the resources to receive the resources.

According to an embodiment of the present invention, utilization of mobile device resources can be maximized. Accordingly, a resource reuse service based on a mobile cloud, which has not been available in a conventional cloud, can be provided.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of using mobile device resources of a mobile device resource provider in a mobile cloud, the method comprising:
requesting use of at least one of the mobile device resources from the mobile device resource provider, wherein the mobile device resources comprise content stored by the mobile device resource provider, a function provided to the mobile device resource provider, and an application installed to the mobile device resource provider; and
receiving the requested mobile device resource of the mobile device resource provider,
wherein, when the requesting of use of at least one of the mobile device resources is a request for use of the content, the requested content is received through download or streaming for the receiving of the requested mobile device resource, and when the requesting of use of at least one of the mobile device resources is a request for use of the function or the application, a result of executing the function or the application is received for the receiving of the requested mobile device resource.

2. The method of claim 1, further comprising:
requesting an authority to use the at least one of the mobile device resources from the mobile device resource provider and receiving the authority, before the receiving of the requested mobile device resource.

3. The method of claim 1, further comprising searching for mobile device resources providable by the mobile device resource provider, before the requesting of use of at least one of the mobile device resources,
wherein the requesting of use of at least one of the mobile device resources comprises requesting use of at least one of the mobile device resources found as a result of the searching for mobile device resources.

4. The method of claim 3, wherein each of the mobile devices found as the result of the searching for mobile device resources comprises a use authority condition for using a corresponding device resource.

5. The method of claim 3, wherein the searching for mobile device resources is performed in a mobile device resource information database for storing and managing information on mobile device resources providable by a plurality of mobile device resource providers.

6. The method of claim 5, wherein the requesting of use of at least one of the mobile device resources and the receiving of the requested mobile device resource are performed through a peer-to-peer communication with the mobile device resource provider.

7. The method of claim 5, wherein the requesting of use of at least one of the mobile device resources and the receiving of the requested mobile device resource are performed through a communication with a server cloud for managing the mobile device resource information database and constructing a virtual desktop infrastructure (VDI).

8. The method of claim 1, wherein the function comprises at least one of a local area network function, a location measurement function, and a near field communication function possessed by the mobile device resource provider.

9. A method of providing mobile device resources to a mobile device resource user, the method comprising:
receiving, from the mobile device resource user, a request for use of at least one of the mobile device resources, wherein the mobile device resources comprise stored content, a provided function, and an installed application; and
transferring, to the mobile device resource user, the requested mobile device resource,
wherein, when a request for use of the content is received as a result of the receiving of the request for use of at least one of the mobile device resources, the requested content is transferred through download or streaming for the transferring of the requested mobile device resource, and, when a request for use of the function or the application is received as a result of the receiving of the request for use of at least one of the mobile device resources, a result of executing the function or the application is transferred for the transferring of the requested mobile device resource.

10. The method of claim 9, further comprising:
receiving, from the mobile device resource user, a request for an authority to use the at least one of the mobile device resources and assigning the authority, before the transferring of the requested mobile device resource.

11. The method of claim 9, further comprising:
receiving, from the mobile device resource user, a request for searching for mobile device resources, before the receiving of the request for use of at least one of the mobile device resources; and
transferring, to the mobile device resource user, information on a providable mobile device resource in response to the search request.

12. The method of claim 11, wherein the transferred information on the available mobile device resource comprises a use authority condition.

13. The method of claim 9, further comprising registering information on a providable mobile device resource in a mobile device resource information database, before the receiving of the request for use of at least one of the mobile device resources,
wherein the requested at least one of the mobile device resources is included in the mobile device resource registered in the mobile device resource information database.

14. The method of claim 13, wherein the receiving of the request for use of at least one of the mobile device resources and the transferring of the requested mobile device resource are performed through a peer-to-peer communication with the mobile device resource user.

15. The method of claim 13, wherein the receiving of the request for use of at least one of the mobile device resources and the transferring of the requested mobile device resource are performed through a communication between the mobile device resource user and a server cloud for managing the mobile device resource information database and constructing a virtual desktop infrastructure (VDI).

16. The method of claim 9, wherein the function comprises at least one of a local area network function, a location measurement function, and a near field communication function possessed by the mobile device resource provider.
